(19) United States
(12) Patent Application Publication
(10) Pub. No.: US 2019/0007544 A1
(43) Pub. Date: Jan. 3, 2019

(54) EMERGENCY SIGNALING DEVICE AND METHOD

(71) Applicant: Bahram Bahramian, Rockville, MD (US)

(72) Inventor: Bahram Bahramian, Rockville, MD (US)

(21) Appl. No.: 15/916,125

(22) Filed: Mar. 8, 2018

Related U.S. Application Data
(60) Provisional application No. 62/468,820, filed on Mar. 8, 2017.

(51) Int. Cl. H04M 1/725; H04M 11/04; G08B 25/01; H04W 4/90

(52) U.S. Cl. CPC H04M 1/72541; H04M 11/04; H04W 4/025; H04W 4/90; G08B 25/016

(57) ABSTRACT

An emergency signaling device and method which uses a separable base unit which is adapted to be releasably connected to a standard smartphone or cell phone. The devices and methods of the inventive alarm system can be used with any smartphone or other mobile telephonic device. The base unit is essentially a separate housing which is sized to partially (or totally) contain known sizes and shapes of smartphones, and may be made model specific. The unit includes a rechargeable battery section, the battery section serving to power the base unit, and to selectively charge the battery of the attached smartphone. In an emergency situation, the user can push a panic button, the button causing the smartphone to dial a predesignated emergency number while simultaneously taking a photo, processing location data, and producing a sharp audio alarm signal. When the receiving phone/emergency contact receives the call, the location information and photo are simultaneously transmitted. The battery section is robust enough to power the smartphone and the emergency audio function, while still having sufficient reserve power to optionally charge the smartphone.

### BACKGROUND OF THE INVENTION

### Field of the Invention

The present invention concerns a mobile emergency signaling device and method. More specifically, the device is attachable to a smartphone, and can be made to emit a loud alarm sound while dialing one or more predesignated numbers and performing other tasks.

### Description of the Prior Art

Mobile emergency/personal safety devices have been around for years. These devices generally fall into two categories; signaling devices (horns, whistles, alarms), and self defense devices such as tasers and mace. The biggest hurdle to the use of these devices is the ease of use in a dangerous emergency such as a robbery. A potential victim will typically only have time to grab one device and initiate operation before being subdued by an assailant. Accordingly, the ideal device/system can be instantly activated and require no further operation by the user.

US patent application 2014/0378089 discloses a wireless mobile emergency device. The device is essentially a single button short range transmitter which can transmit an alarm code or signal which activates a smartphone. The smartphone can then dial one or more pre-designated numbers for emergency help.

U.S. Pat. No. 6,636,732 issued to Boling et al. discloses a cell phone which functions only as an emergency transmitter. The inventive cell phone communicates with a base station which can send for help utilizing a location signal transmitted by the cell phone.

U.S. Pat. No. 8,548,422 issued to Jenkins discloses an emergency signaling device which consists of a stand alone transmitter. The transmitter, operable by a single pushbutton, sends a signal to a base station which may then dial a predetermined emergency contact number.

US patent application number 2008/0030350 issued to Brenner discloses an emergency signaling device which is incorporated into the architecture of an existing cell phone or PDA.

The present invention overcomes the limitations of these and other prior art devices by providing an emergency signaling device and method which uses a separable base unit which is adapted to be releasably connected to a standard smartphone or cell phone. The devices and methods of the inventive alarm system can be used with any smartphone or other mobile telephonic device. The base unit is essentially a separate housing which is sized to partially (or totally) contain known sizes and shapes of smartphones, and may be made model specific. The unit includes a rechargeable battery section, the battery section serving to power the base unit, and to selectively charge the battery of the attached smartphone. In an emergency situation (which may be one of 3 types of emergency as explained below), the user can push a panic button, the button causing the smartphone to dial a predesignated emergency number while simultaneously taking a photo, processing location data, and producing a sharp audio alarm signal. When the receiving phone/emergency contact receives the call, the location information and photo are simultaneously transmitted. The battery section is robust enough to power the smartphone and the audio function, while still having sufficient reserve power to optionally charge the smartphone.

### SUMMARY OF THE INVENTION

It is an object of the invention to provide an improved emergency signaling system.

It is another object of the invention to provide an improved emergency signaling system which employs a smartphone or other telephonic device.

It is another object of the invention to provide an improved emergency signaling system which can be activated with the push of a single button.

It is another object of the invention to provide an improved emergency signaling system where the single push button can perform multiple functions.

It is another object of the invention to provide an improved emergency signaling system where the single push button causes a smartphone or other telephonic device to take one or more photos, emit a repeated or continuous audible alarm, ascertain location information using G.P.S., and transmit the photo and location information to one or more predesignated receiving phones while in a first mode of operation.

It is another object of the invention to provide an improved emergency signaling system having another multiple function push button for emergency medical aid.

It is another object of the invention to provide an improved emergency signaling system having yet another multiple function push button for a car accident scenario.

These and other objects of the present invention will become readily apparent upon further review of the following specification and drawings.

The present invention meets or exceeds all the above objects and goals. Upon further study of the specification and appended claims, further objects and advantages of this invention will become apparent to those skilled in the art.

### BRIEF DESCRIPTION OF THE DRAWINGS

Various other objects, features, and attendant advantages of the present invention will become more fully appreciated as the same becomes better understood when considered with the accompanying drawings, in which like reference characters designate the same or similar parts throughout the several views, and wherein:

FIG. 1 shows a perspective view of the housing for the main component of the invention.

FIG. 2 shows a diagram illustrating overall system function.

FIG. 3 shows a plan view of the insert of FIG. 2 configured in accordance with the invention.

### DETAILED DESCRIPTION OF THE PREFERRED EMBODIMENTS

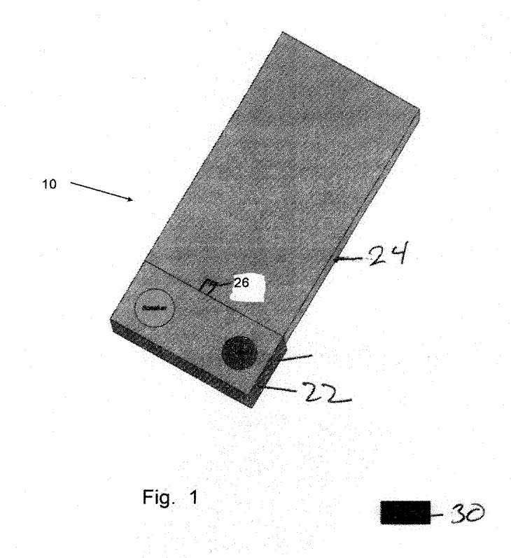

Referring now to FIG. 1, the main housing of the invention, generally designated by the numeral 10, is shown. It can be seen that the housing 10 is sized to receive a smartphone or other mobile telephonic device 20. The housing 10 includes a cradle/phone receiving base 22 and a protective shield cover 24 to contain the phone 20. The shield cover 24 may be detached from the base 22 to allow insertion of the phone 20 as may be apparent to one of skill in the art. The protective shield cover 24 may have an opaque rear cover 25 and a transparent front cover 27 which is touch sensitive to allow functioning of the touch screen of the smartphone 20. Alternatively, the front cover 27 may be eliminated with the rear cover 25 providing protection against impact in case the phone 20 is accidently dropped. An electronic connector or terminal 26 protrudes from the interior of the base 22 and is adapted to provide electrical connection between the base 22 and the phone 20. It can be appreciated that this terminal 26 will be configured for either Android or Iphone, or other mobile device configuration.

The inventive system includes a separate blue tooth transmitter 30 which has one or more buttons on it which buttons function in the same manner as the buttons on the main housing 10 which will be explained in more detail later. The transmitter 30 may be worn around the neck of the user as a pendant, or carried in a pocket, pocketbook or otherwise positioned on or about the user separate from the phone 20. Thus the transmitter 30 can be used to signal the alert even if the phone is lost or taken from the user. The blue tooth transmitter 30 is coupled to the smartphone 20 for a range of about 30 meters. This allows for operation of the system even after an event, e.g., a theft has occurred, even if the phone 20 itself is taken.

Thus, the system has three main components; base and shield cover 22 and 24, the smartphone itself 20, and the blue tooth transmitter 30. Software is required in order for the system to function as would be apparent to one of skill in the art and is explained in more detail below.

Referring now to FIG. 3, the base 22 and associated phone 20 are shown in more detail. It can be seen that the base 22 contains a programmable chip 23 such as an EPROM to store and execute application software specific to the invention. The software preferably allows the system to operate any mobile phone regardless of platform (e.g., android, iphone, blackberry). The base 22 also contains a rechargeable battery 32 which is preferably divided into 2 cells. One cell is used to provide extra/emergency power to the smartphone 20, and the other is used only in the case of an emergency. Thus the system is always prepared for an emergency event regardless of the available battery power for the phone 20.

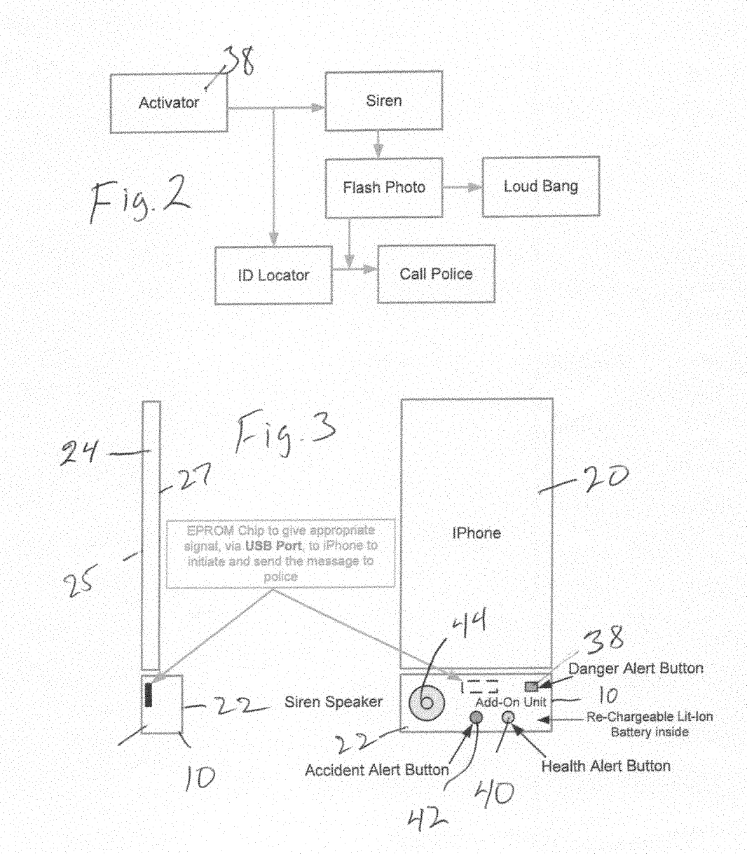

The base 22 has 3 separate color coded emergency push buttons 38, 40, 42 corresponding to the 3 operational modes of the system. The 3 operational modes are unique for an emergency signaling device which operates a mobile telephonic device. In a first operational mode, diagrammatically illustrated in FIG. 2, the system is designed to provide emergency signaling in the event of a robbery or other dangerous event. This mode can be called the personal safety/security mode. In this mode, pushing activator button 38 causes an ID locator portion of the system to acquire and store the user's location information. Simultaneously, an audible alarm, such as a loud siren sound, is produced and is emitted by loudspeaker 44. The loudspeaker 44 is preferably a piezoelectric or other high efficiency driver. Also, the phone's 20 camera will shoot one or more photos in an attempt to ID an attacker. Finally, the system will call the Police or other predesignated number, the party receiving the call will get the potential victim ID, G.P.S. location, and a photo of the attacker or surrounding location.

In a second operational mode button 40 is pushed and the system operates as described above, without the photo step and the loud bang. This mode is useful for a health emergency. In a third operational mode, the system will also function without the photo step and optionally without the loud bang. This mode is useful in the case of a car accident or similar mishap requiring immediate attention.

The system is designed to allow for emergency communication without having to enter a passcode, preferably, only the emergency actions can be performed without entering the passcode so that the device security is not compromised.

From the foregoing description, one skilled in the art can easily ascertain the essential characteristics of this invention and, without departing from the spirit and scope thereof, can make various changes and modifications of the invention to adapt it to various usages and conditions.

It is to be understood that the present invention is not limited to the sole embodiment described above, but encompasses any and all embodiments within the scope of the following claims:

I claim:

1. An emergency signaling system for use with a mobile telephony device comprising:
a base for receiving said telephony device, said base having a source of electrical power and a programmable processor, said base also including one or more activating pushbuttons, and an audio speaker;
whereby activating a single pushbutton causes an alarm sound to emit from said speaker, activates a camera associated with the telephony device, ascertains location information, and transmits the captured camera image and location information to one or more predesignated numbers.

2. The system of claim 1 wherein said system can be operated in a security mode during a personal safety emergency.

3. The system of claim 1 wherein said system can be operated in a health emergency mode during a health emergency.

4. The system of claim 1 wherein said system can be operated in a road hazard/accident mode during a vehicular/traffic emergency.
